(19) United States
(12) Patent Application Publication
(10) Pub. No.: US 2007/0299182 A1
(43) Pub. Date: Dec. 27, 2007

(54) Polyester-Based Thermoplastic Composition, Manufacturing Process and Hollow Bodies Obtained From These Compositions

(76) Inventors: Olivier Mathieu, Marennes (FR); Dominique Dupuis, Crepy-En-Valois (FR)

Correspondence Address: Jean-Louis Seugnet;RHODIA, 8 Cedar Brook Drive, CN 7500, Cranbury, NJ, 08512-7500, US

(21) Appl. No.: 11/630,310

(22) PCT Filed: Jun. 17, 2005
(86) PCT No.: PCT/FR05/01522

§ 371 Date: Jun. 20, 2007

(30) Foreign Application Priority Data
Jun. 22, 2004 (FR) 0406774

(51) Int. Cl. C08K 3/32; C08L 67/02

(52) U.S. Cl. 524/414

(57) ABSTRACT

The present invention relates to a polyester-based thermoplastic composition which may be used for the manufacture of hollow bodies such as bottles, films and sheets, especially for packaging. It relates more particularly to a polyester-based thermoplastic composition and to films, hollow bodies or bottles obtained by forming this composition and having improved gas barrier and mechanical properties. The polyester composition comprises a mineral filler composed of a metal phosphate of a tetravalent metal, dispersed in the form of particles having a thickness of less than 40 nm. The compositions of the invention make it possible to obtain formed articles such as films or transparent preforms.

The present invention relates to a polyester-based thermoplastic composition which may be used for the manufacture of hollow bodies such as bottles, films and sheets, especially for packaging.

It relates more particularly to a polyester-based thermoplastic composition and to films, hollow bodies or bottles obtained by forming this composition and having improved gas barrier and mechanical properties.

For a few decades, polyester, more particularly polyethylene terephthalate, better known by the abbreviation PET, has been increasingly used in the field of the manufacture of hollow containers, more particularly bottles.

Conventionally, the plastic receptacles (bottles) made from polyester (PET) are manufactured according to the techniques of injection moulding/blow moulding of molten polyester. In practice, this manufacture most often involves a first step of manufacturing a preform, having the general shape of a hollow cylindrical tube, closed at one of its ends and with the other end open in the shape of the neck of the bottle that will be obtained in a second step, of hot blow moulding in a mould having the final shape of the receptacle (bottle).

Among the constraints imposed on PET for its use in this field, the transparency of the containers obtained is one of the most important. Copolymers have been proposed for many years, and especially by European Patent 41035, which predominantly comprise ethylene glycol terephthalate repeat units, but also other repeat units derived from the presence of different monomers of terephthalic acid and ethylene glycol. These monomers are known as crystallization retarders and are present in the polyester at varying concentrations, for example between 3.5% and 7.5% of the total content of diacid monomers.

It is, in addition, vital that the polyesters (PET) used for the manufacture of receptacles (bottles) have good thermomechanical performance. In fact, certain food-based liquids packaged in polyester (PET) bottles must be pasteurized, that is to say heated for 20 to 30 minutes at 65-75° C. These bottles are also used in processes of filling with hot foodstuffs, commonly known as hot-fill processes. The polyester (PET) bottles must therefore withstand the thermal stresses. The glass transition temperature of PET is around 75-80° C.

Consequently, the processes described above that comprise a step at a temperature close to or above the high glass transition temperature of the polyester result in deformations that are partly irreversible and permanent. The term “creep” is used to denote these irreversible deformations.

This technical problem of limiting the hot creep of the polyesters (PETs) used as constituent materials of the receptacles (bottles) arises even more when the liquid to be packaged is composed of a carbonated drink. In fact, the gas contained in the drink increases the mechanical stress applied to the walls of the receptacles with, as a consequence, an increase in the creep.

In an attempt to remedy this, it has been proposed to work on the process for manufacturing the hollow bodies and/or on the polyester used.

French Patent Application No. 2 658 119 tackles the first possibility. It describes a process and an installation for manufacturing receptacles such as PET bottles, resistant to relatively severe thermal conditions during their use. This process consists in blow moulding the body of an amorphous PET preform, heated to a temperature above the softening temperature of the PET, in a cooled mould (8 to 40° C.) in order to form an intermediate receptacle of greater volume than the receptacle to be produced, then to heat the body of this intermediate receptacle at 160-240° C. for one to five minutes, at the same time as the neck is heated, then to apply controlled cooling, so as to obtain an intermediate receptacle with a shrunken body and a crystallized neck. The product is blow moulded a second time, to its final dimensions, for 2 to 6 seconds to obtain a final receptacle having improved thermomechanical performance.

This known process has the drawback of being relatively taxing and lengthy to implement, and the thermomechanical performance is insufficient in most pasteurization processes.

In addition, in certain applications, it is also necessary that the walls of the bottles be impermeable to gases. This property is also important in the case of manufacturing packaging films.

In fact, it is important for the preservation of the foodstuffs, contained in the bottle or packaged in a film, that the wall of the packaging be impermeable to the oxygen present in the air. It is still more important that the wall of the bottle be impermeable to carbon dioxide to prevent the gas present in carbonated liquids, such as carbonated drinks, from leaking.

To improve the impermeability of the polyester walls, it has, in particular, been proposed to produce multilayer walls, including a layer that is impermeable to gases, for example a polyamide layer. Methods consisting in depositing amorphous carbon or silica on the outer or inner surface of the bottle have also been proposed.

However, the manufacture of such bottles requires the implementation of complex and expensive manufacturing processes. These bottles are generally reserved for the packaging and storage of commodities requiring a high gas barrier level. This application only represents 1 to 2% of the number of bottles used.

One object of the invention is, in particular, to provide a solution making it possible to produce packaging articles, such as films or bottles, having mechanical and impermeability properties that are compatible with the storage of commodities, especially foodstuffs, and more particularly carbonated drinks, and with hot-fill or pasteurization processes. Another object of the invention is to provide a polyester having a high gas barrier level allowing it to be classed in the category of polyesters known as “high barrier” polyesters.

To this end, a first subject of the invention is a thermoplastic composition comprising at least one thermoplastic material comprising at least 80% by weight of a polyester composed of at least 80% by number of ethylene terephthalate or naphthalene terephthalate repeat units and a solid particulate compound composed of a crystallized phosphate of a tetravalent metal element dispersed in the form of particles having a thickness of less than 40 nm, preferably less than 30 nm.

The “thickness” of the particle is understood to mean the measurement of the thickness of a particle that advantageously has a platelet-like shape.

According to a preferred feature of the invention, these particles are in platelet form or comprise an agglomerate of platelets. The aspect ratio of these particles, i.e. the ratio of the length to the thickness, is advantageously between 5 and 5000. This particle may be an elementary sheet or an aggregate of elementary sheets.

According to one feature of the invention, the weight concentration of solid particles in the composition is between 0.5% and 10% relative to the total weight of the composition, preferably between 0.5% and 5% by weight.

According to another feature of the invention, the particulate compound is a metal phosphate having a crystalline form made of sheets. Furthermore, this compound may be exfoliated into agglomerates of thin elementary sheets or into elementary sheets.

As mineral compounds that are suitable for the invention, mention may be made of zirconium, titanium, cerium and/or tin phosphates or mixed phosphates of these elements. The preferred mineral compound is zirconium phosphate in crystallized form, such as α-ZrP for example.

Thus, the zirconium phosphate may be that described in Application FR 02/16310.

By way of illustration, a description is given below of a first type of zirconium phosphate that is suitable for the invention. This zirconium phosphate corresponds more particularly to the chemical formula Zr(HPO₄)₂.H₂O. It should be noted that some of the hydrogen atoms may be substituted by sodium atoms. Finally, this phosphate may be hydrated.

The zirconium may be partially substituted by another tetravalent element, such as titanium, cerium and tin for example, in a proportion which may range up to 0.2 mol % (substituent/zirconium molar ratio). This substitution possibility also applies to the precursors that will be described later.

The zirconium phosphate is composed of elementary sheets with a length of about 100 nm to 5 μm, more particularly from 200 nm to 2 μm, and with a thickness of about 0.7 nm to 1 nm. The aspect ratio (length/thickness ratio) of these particles is at least about 100, more particularly 142, preferably at least 500, and preferably at most 5000, more particularly at most 2000. The dispersed ZrP particles are either elementary sheets, in the case of an exfoliated ZrP, or aggregates of sheets in which the aspect ratio is advantageously between 5 and 200.

The zirconium phosphate may have an exfoliated or intercalated structure when it is dispersed in a liquid medium, such as water and alcohols for example.

The term “exfoliated structure” is understood to mean a state in which the particles are dispersed in the form of aggregates in which the intersheet distance is several tens of ångströms, for example around 10 to 100 ångströms, or in the form of sheets distributed in a disorganized manner.

The term “intercalated structure” is understood to mean particles dispersed in the form of aggregates of sheets, between which inorganic ions, such as alkali metal ions, are intercalated.

The zirconium phosphate has a high specific surface area, which reflects the exfoliated character of its structure. Thus, this surface area may be at least 200 m²/g, more particularly at least 300 m²/g, and even more particularly at least 400 m²/g. These surface area values are determined by the small-angle X-ray scattering technique.

The zirconium phosphate used in the present invention may be prepared by various processes that will be described hereinafter.

The thermoplastic composition of the invention comprises, as thermoplastic material, a polyester resin chosen from polyethylene terephthalate, polyethylene naphthalate and polyethylene terephthalate copolymers containing at least one crystallization retarder compound or some crystallization retarder repeat units.

In a preferred embodiment of the invention, the polyester resin is obtained from ethylene glycol and terephthalic acid or its esters. These resins are often denoted by the acronym PET.

The term “polyester resin” or “PET” is understood to denote both a homopolymer obtained solely from terephthalic acid monomers or its esters, such as dimethyl terephthalate and ethylene glycol, and copolymers comprising at least 92.5% by number of ethylene terephthalate repeat units.

According to one embodiment of the invention, the polyester comprises at least one crystallization retarder making it possible, especially during cooling of the compression-moulded or injection-moulded article such as a preform, to slow down or retard the crystallization of the polyester in order to thus crystallize it into very small crystals, while avoiding spherulitic crystallization, and to be able to manufacture a transparent article, of which the walls have no mist or “haze”, while obtaining acceptable mechanical properties thereof.

These crystallization retarding agents are difunctional compounds, such as diacids and/or diols, added to the monomer mixture before or during polymerization of the polyester.

As crystallization retarding agent, mention may be made, as examples of diacids, of isophthalic acid, naphthalenedicarboxylic acid, cyclohexanedicarboxylic acid, cyclohexanediacetic acid, succinic acid, glutaric acid, adipic acid, azelaic acid and sebacic acid and, as examples of diols, mention may be made of aliphatic diols comprising from 3 to 20 carbon atoms, cycloaliphatic diols comprising from 6 to 20 carbon atoms, aromatic diols comprising from 6 to 14 carbon atoms and mixtures thereof, such as diethylene glycol, triethylene glycol, isomers of 1,4-cyclohexanedimethanol, 1,3-propanediol, 1,4-butanediol, 1,5-pentanediol, 3-methylpentane-2,4-diol, 2-methylpentane-1,4-diol, 2,2,4-trimethylpentane-1,3-diol, 2-ethylhexane-1,3-diol, 2,2-diethylpropane-1,3-diol, 1,3-hexanediol, 1,4-di(hydroxyethoxy)benzene, 2,2-bis(4-hydroxycyclohexyl)propane, 2,4-dihydroxy-1,1,3,3-tetramethylcyclobutane, 2,2-bis(3-hydroxyethoxyphenyl)propane, 2,2-bis(4-hydroxypropoxyphenyl)propane and mixtures thereof.

The diethylene glycol is often inherently present in the polyesters as it forms during the synthesis by condensation of two ethylene glycol molecules.

Depending on the desired concentration of repeat units comprising a diethylene glycol (DEG) residue in the final polyester, either diethylene glycol is added to the monomer mixtures, or the conditions for synthesis of the polyester are controlled in order to limit the formation of diethylene glycol.

Advantageously, the molar concentration of diethylene glycol in the polyester relative to the number of moles of diacid monomers is less than 3.5%, preferably less than 2 mol %.

Regarding the other crystallization retarders, the molar concentration relative to the number of moles of all the diacids in the monomer mixture, and therefore in the polyester produced, is advantageously less than 7.5%, with the condition that the DEG content must be deduced from this value, if it is present. In other words, the total molar concentration of crystallization retarder is advantageously less than 7.5%, as is indicated in European Patent 41035.

The polyester resins used for the invention have a viscosity index VI that may lie within a very broad range, advantageously between 0.5 dl/g and 1.2 dl/g, preferably between 0.6 dl/g and 1 dl/g.

The viscosity index is generally determined by analysis of the polymer granules obtained at the end of the manufacture.

When the thermoplastic compositions of the invention are used for the production of hollow bodies or bottles, this viscosity index VI may be measured from the polymer constituting the walls of the bottle. To carry out this measurement, a part of the bottle is cut out, then cut into small pieces to allow them to be dissolved.

Generally, the viscosity index of the polyester is barely affected during the process of manufacturing the hollow body. However, the viscosity index measured on the wall of the bottle may be less than or greater than that measured on the feed granules in the injection moulding step. The difference from the value measured on the granules is generally less than 10% of the viscosity index determined on the bottle.

These considerations are also applicable for the viscosity index measured on the polyester forming the walls of the preform obtained after the injection moulding step.

The thermoplastic composition of the invention may contain other components, such as pigments, dyes, brighteners, light and heat stabilizers, antioxidants, acetaldehyde traps, plasticizers and lubricants for example. This list is given solely by way of indication and is not limiting.

Another subject of the invention is a process for manufacturing the thermoplastic compositions described above.

According to a preferred embodiment, the process comprises the usual steps for manufacturing a polyester, the particulate compound being added to the reaction medium at the start of the manufacturing process, in the form of a dispersion or an aqueous, alcohol or aqueous/alcohol sol comprising the zirconium phosphate in exfoliated form, that is to say that the zirconium phosphate particles have, in said dispersion, a thickness of less than 50 μm and an aspect ratio between 5 and 5000. The term “zirconium phosphate” will be used in the description below as a simplification and as, reference to the preferred embodiment of the invention. However, the processes described also apply to other mineral fillers of the invention.

In other words, the dimensions of the zirconium phosphate particles contained in the solution are identical or very close to the dimensions of the particles present in the final thermoplastic composition.

The process for manufacturing the thermoplastic compositions of the invention comprises a first step of esterification or transesterification in the presence or absence of a catalyst. The hydrolysate or esterified product obtained is then polycondensed under reduced pressure in the presence of catalysts, such as antimony, titanium or germanium compounds for example. In this step, alcohol or water is removed in order to allow the polycondensation reaction to progress.

According to the invention, this polycondensation is stopped when the degree of polycondensation or viscosity index has reached the desired value.

The polyester obtained is run through dies in order to obtain rods, which are then converted into granules by cutting.

These granules may be subjected to a heat treatment either to increase the viscosity of the polymer (referred to as an SSP or solid-state postcondensation treatment), or to decrease the acetaldehyde content (drying and evaporation at a temperature below that of an SSP treatment).

According to another embodiment of the invention, in order to limit progression of the degree of polycondensation during the heat treatment described above in order to lower the acetaldehyde content, the polyester may comprise a monofunctional monomer, preferably a monoacid. The molar content of monofunctional monomer is between 0.5 mol % and 3 mol % relative to the total content of diacid monomers. Thus, the monoacids suitable for the invention are, for example, benzoic acid, naphthalenic acid, aliphatic acids having a boiling point compatible with the polyester synthesis process, that is to say advantageously at least above that of ethylene glycol or their esters or alcohols, such as cyclohexanol or aliphatic alcohols also advantageously having a boiling point above that of ethylene glycol.

Various additives, such as brighteners, colorants or other light and heat stabilizing additives or antioxidants for example, may be added to the polyesters of the invention, either at the polymerization step or into the molten polyester before injection moulding.

The fillers are added to the composition in accordance with the known methods of adding mineral fillers. Thus, the filler may be introduced into the reaction medium before the esterification step or the polymerization step. It may also be introduced into the molten polymer, especially into a single-screw or multi-screw extruder. In the latter case, either a filler masterbatch or concentrate, or a filler in the form of solid individual particles, could advantageously be used.

However, according to a first preferred embodiment of the invention, the dispersion containing the particulate compound, especially the zirconium phosphate, is added to and mixed with the monomers present at the esterification or transesterification step.

According to a second embodiment of the invention, the dispersion containing the particulate compound, especially the zirconium phosphate, is added to the reaction medium of the second step or polycondensation step, advantageously at the beginning of this step.

The amount of dispersion added is determined so as to obtain, at the end of the polymerization, a composition containing a given weight concentration of particulate compound.

When the composition manufactured is intended to be used directly for manufacturing hollow bodies, the weight concentration is advantageously between 0.5% and 5% by weight of the final composition, preferably between 0.5 and 3% by weight.

It is also possible, without departing from the scope of the invention, to manufacture compositions comprising a higher concentration of particulate compounds, for example between 5 and 30% by weight. Such compositions are generally referred to as concentrates or masterbatches. They are intended to be mixed with polymer not containing particulate compounds, in order to thus obtain final thermoplastic compositions having a concentration of the particulate compounds defined above, namely between 0.5% and 10%; preferably between 0.5% and 5% by weight.

The dispersion of particulate compounds or zirconium phosphate may be obtained, in a first embodiment, according to the process described above and in the unpublished French Application No. 0216310.

This process makes it possible to obtain exfoliated zirconium phosphate in a liquid, preferably water. This product is in the form of a gel that may be added directly to the reaction medium for manufacturing polyesters.

However, it may be advantageous to improve the fluidity of this gel, by adding a second liquid such as water or an alcohol (ethylene glycol). The addition of ethylene glycol is preferred in order to limit the amount of water introduced into the esterification or polymerization medium.

When the liquid used to form the gel is incompatible with products used in the polymerization reaction medium or in the polyester, this liquid will advantageously be removed and substituted by another compatible liquid such as water or an alcohol, for example.

Water and ethylene glycol are the two liquids preferred to form the phosphate dispersion or the gel. The dispersion or gel of zirconium phosphate may also be prepared according to the processes below.

A first process comprises a first step in which phosphoric acid and a zirconium compound are brought together in an acidic medium.

As initial zirconium compounds, mention may be made of zirconium tetrahalides and zirconium oxyhalides, in particular zirconium oxychloride.

The bringing together of the phosphoric acid and the zirconium compound leads to a precipitation.

A simplified balance for the precipitation reaction is, for example, the following:
2H₃PO₄+ZrOCl₂→Zr(H⁺, PO₄³⁻)₂+2HCl.

The precipitation is preferably carried out in an aqueous medium. The use of phosphoric acid induces acidity of the precipitation medium. The precipitation may advantageously be carried out at acidic pH, preferably controlled, for example, between 0.5 and 2. For this purpose another acid may be used, in addition to the phosphoric acid. By way of example, mention may be made of hydrochloric acid.

At the end of this first step of the process, the precipitate is separated from the reaction medium by any suitable means. Advantageously, it may be followed by a washing step.

The second step of the process consists in putting the precipitate into suspension in a phosphoric acid solution. This solution advantageously has an acid concentration of at most 8.8M.

In a third step, the dispersion obtained is subjected to a heat treatment. This treatment is carried out at a temperature of at least 100° C., preferably at least 110° C.

The heat treatment operation may be conducted by introducing the liquid suspension into a sealed chamber (closed autoclave-type reactor). Under the temperature conditions given above and in an aqueous medium, it may be specified, by way of illustration, that the pressure in the closed reactor may vary between a value above 1 bar (10⁵ Pa) and 165 bar (1.65×10⁷ Pa), preferably between 5 bar (5×10⁵ Pa) and 165 bar (1.65×10⁷ Pa).

A second process for manufacturing a dispersion of a zirconium phosphate suitable for the invention, in the form of crystallized particles having thickness dimensions suitable for the invention, is described hereinafter.

This process comprises a first step in which phosphoric acid and a zirconium compound are brought together in an acidic medium.

As initial zirconium compounds, mention may be made of zirconium tetrahalides and zirconium oxyhalides, in particular zirconium oxychloride.

The bringing together of the phosphoric acid and the zirconium compound leads to a precipitation.

A simplified balance for the precipitation reaction is, for example, the following:
2H₃PO₄+ZrOCl₂→Zr(H⁺, PO₄³⁻)₂+2HCl.

The precipitation is preferably carried out in an aqueous medium. The use of phosphoric acid induces acidity of the precipitation medium. The precipitation may advantageously be carried out at acidic pH, preferably controlled, for example, between 0.5 and 2. For this purpose another acid may be used, in addition to the phosphoric acid. By way of example, mention may be made of hydrochloric acid. It should be noted that the use of hydrofluoric acid is not necessary here.

At the end of this first step of the process, the precipitate is separated from the reaction medium by any suitable means. Advantageously, it may be followed by a washing step, especially using an aqueous solution of phosphoric acid.

The second step of the process consists in putting the precipitate into suspension in a phosphoric acid solution. This solution must have an acid concentration of at most 6M, more particularly at most 5.5M. This concentration is preferably greater than 2.5M and it may, more particularly, be between 3M and 4M. In the latter concentration range, the particles are less agglomerated and the solid/liquid separations are carried out more easily during implementation of the process.

In a third step, the dispersion obtained is subjected to a heat treatment. This treatment is carried out at a temperature that is at least equal to the boiling temperature of the medium undergoing treatment. The temperature must be high enough to allow the product of the invention, with the crystalline structure described above, to be obtained. Generally, but this is not an absolutely necessary condition, the temperature at which the heat treatment takes place is higher when the acid concentration is low. It is preferable for low phosphoric acid concentrations, for example, for those less than or equal to 4M, that this temperature be above the boiling temperature.

More particularly, this heat treatment temperature is at least 120° C. It may be, for example, between 120° C. and 170° C., this upper value not being critical, but mainly limited by economic or equipment constraints.

The heat treatment operation may be conducted under reflux when the temperature at which the treatment is carried out is equal to, or close to, the boiling temperature of the medium. For higher temperatures, the treatment may be carried out by introducing the liquid suspension into a sealed chamber (closed autoclave-type reactor). Under the temperature conditions given above and in an aqueous medium, it may be specified, by way of illustration, that the pressure in the closed reactor may vary between a value above 1 bar (10⁵ Pa) and 20 bar (2×10⁶ Pa), preferably between 2 bar (2×10⁵ Pa) and 6 bar (6×10⁵ Pa).

The heat treatment is generally conducted in air.

The duration of the heat treatment may vary within wide limits, for example between 1 and 8 hours, preferably between 4 and 5 hours.

At the end of the heat treatment, the zirconium phosphate according to the invention is obtained, which is present in the form of a suspension or dispersion in water.

This dispersion may be used as is or it may be treated to modify the concentration and/or the nature of the liquid medium. This treatment may consist of separation of the solid, for example by centrifugation, then redispersion, optionally after a washing step in a fresh liquid of identical or different type.

These processes for manufacturing zirconium phosphate dispersions are given only by way of indication.

In fact, all processes for obtaining a dispersion in the form of a gel or suspension of zirconium phosphate particles, having the size characteristics (aspect ratio and thickness) described in the present application, are suitable.

Moreover, all processes for obtaining individual zirconium phosphate particles, having the size characteristics (aspect ratio and thickness) described in the present application, are suitable. These particles could be added directly to the reaction medium, without the need to first disperse them in a liquid, such as water or an alcohol.

The formulation of the compositions thus produced may be determined by various conventional analysis techniques, such as measurement of the ash content, X-ray diffraction analysis and transmission electron microscope analysis.

These compositions may find many different applications, such as the manufacture of formed articles, such as films and sheets, for example for packaging, or the manufacture of hollow bodies by injection-blow moulding.

In the case of manufacturing sheets or films, an important application is the manufacture of thermoformable films or sheets obtained by extrusion or moulding without orientation of the polymer chains. The films and sheets thus obtained have improved mechanical and gas barrier properties and are transparent.

One particular and important use of these compositions, which constitutes one subject of the present invention, is the manufacture of hollow bodies, such as preforms and bottles by the injection-blow moulding technique.

In this use, the thermoplastic composition conforming to the invention is produced in the form of granules of sizes that vary to a greater or lesser extent.

These granules are advantageously dried to obtain a moisture content of less than 50 ppm, preferably less than 20 ppm. This drying step is not obligatory if the moisture content of the polyester is sufficiently low.

The granules are then introduced into the injection-blow moulding processes for manufacturing hollow containers such as bottles. These processes, described in numerous publications and used industrially, on a large scale, comprise a first step of injection moulding for manufacturing preforms. In a second step, the preforms are blow moulded to the shape of the desired bottles, with optionally a biaxial-stretching step, after optionally reheating the preform if using cold preforms.

The preforms are obtained, for example, by melting the resin in a single-screw or twin-screw injection moulding machine, also allowing the polyester to be plasticized and fed, under pressure, into a distributor equipped with heated nozzles and obturators, for example at a temperature between 260° C. and 285° C.

The resin is injected into at least one preform mould equipped with suitable cooling means to control the cooling rate of the preform and to thus avoid spherulitic crystallization, making it possible to obtain, preferably if this result is desired, a preform having no haze in the walls or opaque walls.

After cooling, the preform is ejected and cooled to room temperature or introduced directly, without cooling, into a blow moulding installation as described below.

In this preform manufacturing process, the polyester is melted at a temperature of around 280° C., for example between 270 and 285° C., then injected into the moulds. The lowest possible injection temperature will be used in order to limit the formation of acetaldehyde, in particular to decrease the rate of acetaldehyde formation.

Moreover, it is advantageous for the moulds to be cooled to a temperature between 0° C. and 10° C. This cooling is achieved by using any suitable coolant such as, for example, glycol water.

Advantageously, the injection moulding/cooling cycle time is around 10 seconds to 20 seconds.

The polyester forming the wall of the preform obtained according to the process has a viscosity index between 0.45 dl/g and 1.2 dl/g, advantageously between 0.60 dl/g and 1 dl/g.

The acetaldehyde content in the preform is advantageously less than 10 ppm, preferably less than 6 ppm. However, this concentration may be higher depending on the nature of the products to be stored in the bottle.

The preforms thus obtained are generally used in blow moulding processes for manufacturing bottles. These blow moulding processes are also widely used and described in numerous publications.

They generally consist in introducing the preform into a blow moulding installation, with or without overstretching, which incorporates heating means.

The preform is heated at least above the T_{g} (glass transition temperature) of the polymer, then stretched using a stretching rod and pre-blow moulded by injection of a pressurized gas at a first pressure for a first period.

A second injection of a gas at a second pressure makes it possible to obtain the final shape of the bottle before its injection moulding, after cooling.

Advantageously, the heating temperature of the preform is between 90° C. and 110° C. This heating is carried out by any suitable means, for example by infrared radiation directed onto the outer surface of the preform.

Advantageously, the pre-blow moulding of the preform takes place at a first pressure between 4×10⁵ Pa and 10×10⁵ Pa (4 bar and 10 bar) for a period between 0.15 and 0.6 seconds.

The second blow moulding is carried out at a second pressure between 3×10⁶ Pa and 4×10⁶ Pa (30 and 40 bar) for a second period between 0.3 and 2 seconds.

The use of the thermoplastic compositions according to the invention makes it possible to obtain hollow bottles or containers having better mechanical properties than those obtained with an unfilled polyester.

Furthermore, the gas impermeability properties, especially for carbon dioxide and oxygen, are significantly improved. Thus, it will be possible to use such bottles for the storage of carbonated drinks, especially highly carbonated drinks, on the one hand, and products that are sensitive to the presence of oxygen on the other hand.

In addition, the use of particles, for example having dimensions in a determined range, especially a thickness lying in the ranges described previously, makes it possible in particular to produce transparent preforms and translucent bottles. In fact, it is possible to obtain preforms, then bottles, having no haze or cloudy parts.

The bottles obtained with the compositions of the invention are used for packaging and storage of any liquid product, such as foodstuffs like carbonated or still drinks, generally known under the generic term “soft drinks”, and also carbonated or still, natural, spring or mineral waters. They may also be used for storing beer, milk or the like.

Other advantages and details of the invention will appear more clearly in view of the examples given below, solely by way of illustration and having no limitation.

The characteristics of the compositions of the invention are determined according to the following methods:
Viscosity index (VI, in ml/g): measurement according to the standard ISO 1628/5: measured in a 0.5% solution of the composition in a 50/50 mixture by weight of phenol/orthodichloro benzene, at 25° C. The polymer concentration used for the viscosity index calculation is the actual polymer concentration, taking into account the amount of particles present in the composition.
Coloration according to the CIE Lab system: measurement of L*, a*, b* with a Minolta CR310 colorimeter.
Thermomechanical properties of the crystallized polymer:
   modulus at 170° C., glass transition temperature (T_{g}) (determined by measurement of the loss tangent). The measurements were carried out, on a RHEOMETRICS RSA2 machine, on polymer test pieces of length 56 mm, width 10 mm and thickness 4 mm. The test pieces are first dried and crystallized, for 16 h at 130° C.
Thermomechanical properties of the amorphous polymer:
   modulus at 100° C., glass transition temperature (T_{g}) (determined by measurement of the loss tangent) and crystallization start temperature. The measurements were carried out in rectangular torsion, under a 1.5% deformation and a frequency of 1 hertz, with a Dynamic Analyser RDA II machine from RHEOMETRICS, on polymer test pieces of length 27 mm, width 4 mm and thickness 2 mm.
Oxygen permeability: the oxygen transmission coefficient was measured according to the standard ASTM D3985 under the following specific conditions.
   Measurement conditions:
   Measurements with 100% oxygen on 3 test pieces of 0.5 dm²;
   Stabilization time: 24 h;
   Measurement device: Oxtran 2/20.
Carbon dioxide permeability: the carbon dioxide transmission coefficient was measured according to the document ISO DIS 15105-2 Annex B (chromatographic detection method).
   Measurement conditions:
   Temperature: 23° C.;
   Humidity: 0% RH;
   Measurement on 2 test pieces of 0.5 dm²;
   Stabilization time: 48 h;
   Measurement device: Oxtran 2/20.
   Chromatographic conditions:
   Oven: 40° C.;
   Columns: Porapak Q;
   Detection by flame ionization, the detector being preceded by a methanization oven.
   Calibration of the chromatograph with gas standards at known carbon dioxide concentrations.

### EXAMPLE 1

Preparation of the Zirconium Phosphate Filler:

preparation of the crystallized zirconium phosphate:

First, an aqueous solution of zirconium oxychloride containing 2.1 mol/l of zirconium compound, expressed as moles of ZrO₂, was prepared.
The following solutions were added to a 1-litre stirred reactor at room temperature:
hydrochloric acid: 50 ml;
phosphoric acid: 50 ml; and
water: 150 ml.
After stirring the mixture, 140 ml of the aqueous 2.1 mol/l solution of zirconium oxychloride were added continuously with a flow rate of 5.7 ml/min.
The stirring was maintained for 1 hour after the zirconium oxychloride solution had been added.
After removal of the mother liquors, the precipitate was washed with 1200 ml of a 20 g/l H₃PO₄ solution, then with 4 l of deionized water, until a conductivity of less than 2 mS in the supernatant solution was attained. A zirconium phosphate-based precipitate cake was obtained, this cake was dried at 50° C.
The dried product was dispersed in 1 litre of 8.8M aqueous phosphoric acid solution, the dispersion thus obtained was transferred into a 2 litre reactor, then heated at 114° C. This temperature was maintained for 5 hours.
The dispersion obtained was centrifuged, the cake was washed with water until a supernatant solution having a conductivity of less than 1 mS was obtained. After washing, the cake was dispersed in water at a concentration corresponding to a solids content equal to 18.1%, the pH of the dispersion was 2.5.
A dispersion of a zirconium phosphate-based crystallized compound was obtained, which had the following characteristics:
The analysis by Transmission Electron Microscopy (TEM) displayed particles with a size between 100 and 200 nm and with an average size of 140 nm.
The products were analysed on a Philipps PW1700 diffractometer, equipped with fixed slits and a copper anode (λₘ=1.5418 Å).
The operating conditions were from 50 to 70° (2θ), with a step of 0.020° and a time of 1 second per step.
The intersheet distance measured was 7.5 Å ((002) plane), the size of the crystallites along the (002) plane was 50 nm.
preparation of the dispersion of exfoliated ZrP:
240 g of the dispersion thus obtained were diluted to 4800 ml with stirring, 61 ml of 5N NaOH were added in order to obtain an Na/P atomic ratio close to 1. The pH of the dispersion was then 11. Thus a zirconium phosphate and a sodium phosphate, precursor of a sodium phosphate with an exfoliated structure, were obtained.
The dispersion was left under stirring for one hour. Next, hydrochloric acid was added to lower the pH to 2. The dispersion was centrifuged, the cake in gel form or the lower phase was washed with water until the supernatant solution had a conductivity less than 1 mS/cm and a pH between 3 and 4. The gel thus recovered comprised an exfoliated zirconium phosphate and had a solids content of 5.4% by weight.
The analysis of this gel by cryometry and transmission electron microscopy showed that it was comprised of sheets of zirconium phosphate distributed in a disorganized manner. The x-ray analysis displayed an amorphous structure.

Synthesis of Filled PET:

Introduced into a 7.5 litre polymerization reactor, allowing about 3 kg of polymer to be obtained by polycondensation, fitted with a stirrer, of which the motor torque was controlled so as to follow the viscosity of the reaction medium, with a distillation column to remove the water formed during the esterification, and also the excess of ethylene glycol, and with a direct vacuum circuit for the polycondensation step, were:

2854.5 g of terephthalic acid;

67.2 g of isophthalic acid;

1309.0 g of ethylene glycol; and

626 g of the above gel of ZrP dispersed in water.

After a nitrogen purge, the reaction medium was heated to 275° C. with stirring and under an absolute pressure of 6.6 bar.

The esterification time was 60 minutes. The pressure was then brought back to atmospheric pressure over 20 minutes.

At the start of the polymerization step, 275 ppm, expressed as Sb, of an antimony compound were introduced into the reaction medium.

The pressure was maintained for 20 minutes at atmospheric pressure, before gradually putting the reaction medium under a vacuum, from 1 bar to less than 1 mm of mercury in 90 minutes.

The reaction mass was brought to 285° C. when the pressure dropped below 1 mm of mercury.

The polycondensation time was defined as the time needed to reach the targeted viscosity level from the moment when the pressure was less than 1 mm of mercury.

Once the viscosity level was reached, the stirring was stopped and the reactor was put under a pressure of 3 bar. The polymer obtained was run through a die to produce a rod which was chopped into granules.

### EXAMPLE 2

Example 1 was reproduced, but tripling the mass of ZrP in order to obtain a weight concentration equal to 3% of ZrP in the polyester composition.

### EXAMPLE 3

A composition was prepared in accordance with Example 1, except that the aqueous sol of mineral fillers was prepared as given below:

Preparation of the ZrP filler:

An aqueous solution of zirconium oxychloride containing 2.1 mol per litre of ZrO₂ was prepared.

The following solutions were added to a 500 ml stirred reactor at room temperature:
hydrochloric acid: 50 ml;
phosphoric acid: 50 ml; and
water: 150 ml.

After stirring the mixture, 140 ml of the aqueous 2.1 mol/litre solution of zirconium oxychloride were added continuously with a flow rate of 5.7 ml/min.

The stirring was maintained for 1 hour after the zirconium oxychloride solution had been added.

After removal of the mother liquors, by centrifugation, the precipitate was washed with 1.2 l of a 20 g/l H₃PO₄ solution, then with 4 l of water, until a conductivity of less than 2 mS/cm of the supernatant waters was attained. A cake based on zirconium phosphate was then obtained, which was dried at 50° C. 90 g of this product were recovered.

60 g of the recovered solid were dispersed in 230.6 g of 85% phosphoric acid and 524.9 g of water (being an acid concentration of 3 moles/litre), the dispersion thus obtained was transferred into a 1 litre autoclave, then heated to a temperature of 150° C. This temperature was maintained for 5 hours.

The dispersion obtained was centrifuged. The lower or heavy phase was washed with water until a conductivity of the supernatant phase of less than 1 mS/cm was obtained. The cake or heavy phase derived from the last centrifugation was dispersed in water so as to obtain a solids content of the dispersion equal to about 10%. The pH of the dispersion was 2.6.

A dispersion of a zirconium phosphate-based crystallized compound was obtained, which had the following characteristics:

The size of the particles measured with a Coulter counter was 1.25 microns (D₅₀). The TEM analysis displayed particles with a size between 150 and 400 nm.

The products were analysed on a PW1700 diffractometer, equipped with fixed slits and a copper anode (λₘ=1.5418 Å).

The operating conditions were from 5° to 70° (2θ), with a step of 0.020° and a time of 1 second per step.

The intersheet distance measured was 7.5 Å ((002) plane), the size of the crystallites along the (002) plane was 18 nm.

The solids content was 10.4%.

Production of the filled material was carried out following the protocol described in Example 1.

The final characteristics of the PET are given in Table 1.

### EXAMPLE 4

### Comparative Test 1

Preparation of the crystallized zirconium phosphate:
An aqueous solution of zirconium oxychloride containing 2.1 mol/l of zirconium compound, expressed as moles of ZrO₂, was prepared.
The following solutions were added to a 1 litre stirred reactor at room temperature:
hydrochloric acid: 50 ml;
phosphoric acid: 50 ml; and
water: 150 ml.
After stirring the mixture, 140 ml of the aqueous 2.1 mol/l solution of zirconium oxychloride were added continuously with a flow rate of 5.7 ml/min.
The stirring was maintained for 1 hour after the zirconium oxychloride solution had been added.
After removal of the mother liquors, the precipitate was washed with 1200 ml of a 20 g/l H₃PO₄ solution, then with 4 l of deionized water, until a conductivity of less than 2 mS in the supernatant solution was attained. A zirconium phosphate-based precipitate cake was obtained, this cake was dried at 50° C.
The dried product was dispersed in 1 litre of 8.8M aqueous phosphoric acid solution, the dispersion thus obtained was transferred into a 2-litre reactor, then heated at 114° C. This temperature was maintained for 5 hours.
The dispersion obtained was centrifuged, the cake was washed with water until a supernatant solution having a conductivity of less than 1 mS was obtained. After washing, the cake was dispersed in water at a concentration corresponding to a solids content equal to 18.1%, the pH of the dispersion was 2.5.
A dispersion of a zirconium phosphate-based crystallized compound was obtained, which had the following characteristics:
The TEM analysis displayed particles with a size between 100 and 200 nm and with an average size of 140 nm.
The products were analysed on a Philipps PW1700 diffractometer, equipped with fixed slits and a copper anode (λₘ=1.5418 Å).

The operating conditions were from 5° to 70° (20), with a step of 0.020° and a time of 1 second per step.

The intersheet distance measured was 7.5 Å ((002) plane), the size of the crystallites along the (002) plane was 50 nm.

A composition was prepared in accordance with Example 1, except that the aqueous sol of mineral fillers was the dispersion prepared above.

The polymer composition was produced following the protocol described in Example 1.

The final characteristics of the PET material obtained are given in Table 1.

### EXAMPLE 5

### Comparative Test 2

The process for manufacturing the polyester of Example 1 was applied, no filler was introduced into the reactor.

The characteristics of the polymers obtained are collated in Table 1 below:

TABLE 1

| | | Example | | | | |
|---|---|---|---|---|---|---|
| | | | | | 4 | 5 |
| | | | | | (compar- | (compar- |
| | | 1 | 2 | 3 | ative) | ative) |
| Ash content | | 1.0 | 3.2 | 0.9 | 1.0 | 0 |
| (wt %) | | | | | | |
| Viscosity index | | 70 | 74 | 77 | 76.7 | 73 |
| (ml/g) | | | | | | |
| Coloration | L* | 68.2 | 68.1 | 70 | 69.8 | 76 |
| | a* | 2.3 | 4 | 1.9 | 1.9 | −1.6 |
| | b* | 11 | 12 | 9 | 9 | 10 |
| Particle | | 30 | 30 | 25 | 50 | — |
| thickness (nm) | | | | | | |

The thickness of the particles was determined from a TEM section and measurement of the thickness on the micrographs obtained.

Determination of the permeability and transparency properties.

Before conversion, the polymer granules were crystallized by storage under vacuum for 16 h at 130° C.

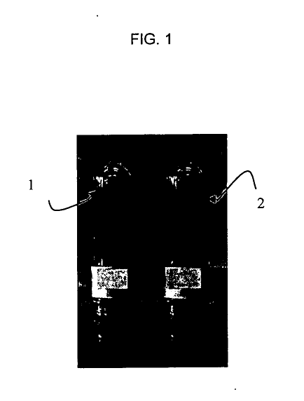

In order to verify the processability and the appearance of the preforms obtained with the materials from Examples 1, 3 and 4, the polymers were injection moulded on an LX 160T machine having a 42 mm screw and a twin-cavity mould. Photographs representative of the transparency of the preforms are illustrated in FIG. 1.

In this image, preform 1 was obtained with the polymer of Example 1, preform 2 was obtained with the composition of Example 3.

With the composition of Example 4, the injection moulding of sheets of various thicknesses showed that it was impossible to obtain transparent sheets for thicknesses greater than or equal to 2 mm.

Measurements of the oxygen and carbon dioxide permeability were carried out, the results are described in Table 2 below:

These measurements were carried out from bottles obtained by free blow moulding of preforms manufactured respectively with the compositions of Examples 2 and 5 according to the process described above.

TABLE 2

| Compounds | Example 5 | Example 2 |
|---|---|---|
| CO₂ Permeability - 0% RH | 88 | 52 |
| (cm³/m² · 24 h · bar · 100 μm) | | |
| O₂ Permeability - 0% RH | 23 | 19 |
| (cm³/m² · 24 h · bar · 100 μm) | | |

The mechanical properties of the crystallized polyester and of the amorphous polyester were determined according to the methods described previously. The results are collated in Table 3 below:

TABLE 3

| | Amorphous PET | | | | | |
|---|---|---|---|---|---|---|
| | | | | Crystal- | | |
| | | | | lization | Crystallized PET | |
| | Modulus | Gain in | | start | Modulus | |
| | at | modulus | | temper- | at | |
| | 100° C. | at | T_{g} | ature | 170° C. | Tg |
| | (MPa) | 100° C. | (° C.) | (° C.) | (MPa) | (° C.) |
| Example 5 | 1.36 | — | 75 | 103 | 160 | 101 |
| (reference) | | | | | | |
| Example 1 | 1.68 | 24% | 79.5 | 110 | — | — |
| Example 2 | — | — | — | — | 180 | 106 |
| Example 3 | 1.52 | 12% | 79 | 112 | — | — |

1-22. (canceled)

23. A thermoplastic composition comprising at least one thermoplastic material comprising at least 80% by weight of a polyester composed of at least 80% by number of ethylene terephthalate or naphthalene terephthalate repeat units, said composition having a solid particulate compound composed of a crystallized phosphate of a tetravalent metal element dispersed in the form of particles having a thickness of less than 40 nm.

24. The composition according to claim 23, wherein the thickness of the metal phosphate particles is less than 30 nm.

25. The composition according to claim 23, wherein the particles have an aspect ratio between 5 and 5000.

26. The composition according to claim 23, wherein the solid particles have a weight concentration of between 0.5 and 10% relative to the total weight of the composition.

27. The composition according to claim 26, wherein the weight concentration is between 0.5 and 5% by weight relative to the total weight of the composition.

28. The composition according to claim 23, wherein the particulate compound is zirconium phosphate, titanium phosphate, cerium phosphate, tin phosphate or mixed phosphates of these metals.

29. The composition according to claim 28, wherein the particulate compound is a crystallized zirconium phosphate.

30. A process for manufacturing a thermoplastic composition as defined in claim 23, comprising the steps of:
a) reacting at least one diol with at least one diacid or diacid derivative in a esterification medium, to obtain an ester of the diol;
b) polycondensing in a polycondensation medium said diol ester to obtain a polyester, and
c) adding into the esterification medium or into the polycondensation medium, a dispersion of particulate compound of the tetravalent metal phosphate compound, having a particle thickness of less than 40 nm.

31. The process according to claim 30, wherein the particulate compound is added into the esterification medium at the start of the esterification step a).

32. The process according to claim 30, wherein the dispersion of particulate compound is added into the polycondensation medium at the start of the polycondensation step b).

33. The process according to claim 30, wherein the liquid medium of the particulate compound dispersion is water, an alcohol or a water/alcohol mixture.

34. The process according to claim 33, wherein the alcohol is ethylene glycol.

35. The process according to claim 30, wherein the dispersion of particulate compound is added in an amount determined so as to obtain a weight concentration of particulate compound in the composition of between 0.5% and 10%.

36. The process according to claim 35, wherein the dispersion of particulate compound is added in an amount determined so as to obtain a weight concentration of particulate compound in the composition of between 5 and 30% in the final composition.

37. The process according to claim 30, wherein the dispersion of particulate compound is obtained by dissolving a crystallized zirconium phosphate gel.

38. The process according to claim 30, wherein the compound particles have an aspect ratio between 5 and 5000.
